(19) United States
(12) Patent Application Publication
(10) Pub. No.: US 2024/0084970 A1
(43) Pub. Date: Mar. 14, 2024

(54) DOUBLE-WALL TANK AND AN ASSEMBLING METHOD OF SAID DOUBLE-WALL TANK

(71) Applicant: Airbus Operations S.L.U., GETAFE (ES)

(72) Inventor: Jorge BALLESTERO MÉNDEZ, GETAFE (ES)

(21) Appl. No.: 18/463,022

(22) Filed: Sep. 7, 2023

(30) Foreign Application Priority Data
Sep. 13, 2022 (EP) 22382847.6

(51) Int. Cl. F17C 3/08

(52) U.S. Cl. CPC F17C 3/08; F17C 2201/0171; F17C 2203/0391; F17C 2203/0629; F17C 2203/0673; F17C 2223/0161

(57) ABSTRACT

A double-wall tank comprising at least one piping connecting system and to a method for assembling a double-wall tank provided with at least one piping connecting system. An inner connecting part is coupled to an comprises an inner part hole. The inner part hole and an inner wall hole of the inner wall are coincident. An outer connecting part is coupled to an outer wall and comprises an outer part hole. The outer part hole and an outer wall hole of the outer wall are coincident. One or more pipes pass through the outer part hole, the outer wall hole, the inner part hole, the inner wall hole. The pipe is coupled, in a fluid-tight fit, to the inner part hole and the outer part hole.

### CROSS-REFERENCES TO RELATED APPLICATIONS

This application claims the benefit of European Patent Application No. 22382847.6, which was filed on Sep. 13, 2022, the entire disclosure of which is incorporated herein by way of reference.

### TECHNICAL FIELD OF THE INVENTION

The present invention belongs to the field of fluid storage systems and manufacturing methods of said fluid storage systems. Particularly, the present invention refers to a double-wall tank comprising at least one piping connecting system and to a method for assembling a double-wall tank provided with at least one piping connecting system.

### BACKGROUND OF THE INVENTION

Due to environmental reasons, challenges to reduce the use of fossil fuels must be increasingly faced. In this scenario, hydrogen produced on the basis of renewable energy is a reasonable candidate for efficient energy supply. Its high energy density makes it an emerging alternative fuel for aircraft applications.

In particular, hydrogen is an attractive fuel for high-altitude short-medium range aircraft because it contains about 6.2 times the energy per kilogram as compared with traditional hydrocarbon fuels. Therefore, in aircraft applications, said high specific energy of hydrogen may be a key enabler. However, practical considerations have largely prevented its use. While the specific energy of hydrogen is very high, the energy per unit volume is comparatively low. Liquid hydrogen (“LH2”) enhances its energy density relative to gaseous form while allowing to reduce the mass of the tank required to confine the hydrogen within as a result of the lower pressure in liquid state. Liquid hydrogen at 20 K and 1 bar pressure has a density of 70 g/l compared to the 40 g/l of gaseous hydrogen at 88 K and 700 bar. Only cryo-compressed hydrogen has a higher density, with a value of 80 g/l at 38 K and 300 bar. According to these parameters, liquefied cryogenic form allows efficient storage at low pressure.

In this regard, LH2 cryotanks are one of the key components of the structure of future generations of heavy lift launch vehicles, space exploration structures and new green aircrafts. It is in aircraft where the greatest challenges lie in developing hydrogen storage systems because of the need for higher dormancy times requiring good insulating solutions, permeation properties, combined with reduced weight. Some of the key challenges are geometry, temperature, hydrogen embrittlement, permeation, leakage, etc.

In order to take advantage of the high specific energy of hydrogen, the associated tanks should be preferably light weight and must be thermally insulated. The method of insulating a tank must deal with several types of heat transfer: conduction through solids, conduction and convection through gas, and radiation. Most methods of effecting high-performance insulation rely on an ultra-vacuum to nearly eliminate the conduction and convection gas heat transfer.

Taking into account the aforementioned conditions, known solutions currently in use, which are implemented in industries other than the aeronautical industry and are therefore not constrained by said high-demanding conditions in which aircraft operate, consist of tanks that include structures and elements such as the following:

Double-wall tanks comprising an outer jacket and an inner pressure vessel. These double-wall tanks are normally made from aluminum or steel, and are among the most conventional tanks used, mainly because they are the cheapest tanks to manufacture. However, they are also the heaviest type of tanks used for confining cryo-compressed hydrogen.

Metallic pressure vessel/liner with a composite reinforcement overwrap. The metal and the composite material share structural load. Manufacturing costs with respect to the previous alternative are reduced and also the weight is significantly reduced.

### SUMMARY OF THE INVENTION

The present invention provides a double-wall tank, and a method for manufacturing a double-wall tank. Further embodiment of the invention are also provided for by the present invention. In the dependent claims, embodiments of the invention are defined.

In a first inventive aspect, the invention provides a double-wall tank comprising:
an inner wall defining an inner chamber configured to house a fluid, wherein the inner wall comprises at least one inner wall hole;
an outer wall defining an outer chamber which houses the inner chamber within, wherein the outer wall comprises at least one outer wall hole,
a piping connecting system comprising:

at least one inner connecting part coupled to the inner wall, wherein the inner connecting part comprises at least one inner part hole, and wherein the inner connecting part is positioned relative to the inner wall such that the inner part hole and the inner wall hole of the inner wall are coincident; and
at least one outer connecting part coupled to the outer wall, wherein the outer connecting part comprises at least one outer part hole, and wherein the outer connecting part is positioned relative to the outer wall such that the outer part hole and the outer wall hole of the outer wall are coincident;
and
at least one pipe arranged passing:
through an outer part hole and through an outer wall hole; and
through an inner part hole and through an inner wall hole,
wherein the pipe is coupled, by means of a fluid-tight fit, to said inner part hole and said outer part hole.

The double-wall tank according to the invention comprises four basic structural elements: an inner chamber intended for housing a fluid within, and which is defined by the inner wall of the so called double-wall tank; an outer chamber, defined by the outer wall, which is arranged surrounding said inner chamber, said inner and outer walls being separated by a distance defined by an intermediate gap between them; a piping connecting system; and at least one pipe coupled, by means of a fluid-tight fit, to said piping connecting system.

Also, from another structural approach to the double-walled tank, it may be understood that the inner wall defines an inner vessel, whereas the outer wall defines an outer jacket that surrounds and encloses said inner vessel within.

The intermediate gap between the inner wall and the outer wall is intended for providing thermal insulation to the inner chamber. In particular, said inner chamber, in the case of containing a cryo-compressed fluid, such as hydrogen, will be exposed to extremely low temperatures. Accordingly, said intermediate gap undergoes, during operation, a thermal gradient according to which temperatures will progress from a lower limit corresponding to the temperature of the outer surface of the inner wall defining the inner chamber, to an upper limit corresponding to the temperature of the inner surface of the outer wall, that is, a temperature close to the room temperature surrounding the double-wall tank.

The piping connecting system and the at least one pipe are configured to allow access to the inner chamber, while assuring the tightness of the fluid stored inside the inner chamber and allowing keeping a vacuum in the gap between the inner wall and the outer wall. This is achieved by at least one inner connecting part coupled to the inner wall and at least one outer connecting part coupled to the outer wall.

The inner wall comprises at least one inner wall hole. The inner connecting part comprises at least one inner part hole and is positioned relative to the inner wall such that an inner part hole and an inner wall hole of the inner wall are coincident, thus allowing the pass of a pipe through the inner part hole and through the inner wall hole.

In turn, the outer wall comprises at least one outer wall hole. The outer connecting part comprises at least one outer part hole and is positioned relative to the outer wall such that an outer part hole and an outer wall hole of the outer wall are coincident, thus allowing the pass of the pipe through an outer part hole and through an outer wall hole.

The pipe is coupled, by means of a fluid-tight fit, to the corresponding inner part and outer part holes by coupling the pipe to the inner connecting part and to the outer connecting part, without acting on the inner or outer wall, thus preserving the structural integrity of the tank. This avoids having to perform welding operations directly on the corresponding inner or outer wall that could locally affect or damage the structural integrity of said wall. In this regard, it also avoids machining or using bolts or rivets to attach and anchor the pipes to the inner and/or outer walls of the tank, which could lead to the appearance of stress accumulation areas that could favor the initiation and propagation of cracks or even corrosion.

Advantageously, the present invention provides high level of product flexibility thanks to the inner and outer connecting part. In particular, said connecting parts provide a connecting interface between the corresponding inner or outer wall and the mechanical piping systems, thus avoiding direct contact between them, which allow to select the material of the pipes and the corresponding wall independently of each other. It shall be understood that any connecting part coupled to the inner wall or to the outer wall is coupled to the corresponding wall by means of a fluid-tight fit.

Regarding said materials used to manufacture the double-wall tank, in an embodiment, at least one of the inner or outer walls is made of Fiber Reinforced Polymer (“FRP”) material (also referred to as “composite materials”).

Advantageously, the use of composite materials for the manufacturing of the walls provides the benefits of composite material in terms of material performance, weight saving, material cost, production and industrialization features.

The use of composite materials for the inner and/or outer walls results in a much lighter double-wall tank compared to conventional tanks using metallic parts. Furthermore, the Gravimetric Index (“GI”), that is, the weight of liquid hydrogen vs. the weight of the tank is also improved compared to a metallic tank, reaching maximum values close to 50%, compared to typical values of metallic tanks ranging between 30-35%.

Advantageously, by virtue of the reduced weight properties of the double-wall tank of the invention provided by the use of composite materials, as well as of the optimum insulation properties provided by the vacuum kept in the intermediate gap between the inner wall and the outer wall, the double-wall tank of the invention provides a solution to the greatest challenges in developing hydrogen storage systems which require high dormancy times necessary for commercial aeronautics applications.

The vacuum condition in said gap between the inner wall and the outer wall, may in a particular embodiments of the double-wall tank be under ultra-high vacuum (“UHV”) conditions. According to this vacuum regime, operating pressure is lower than about 100 nano Pascals (1.0×10⁻⁷ Pa; 1.0×10⁻⁹ mbar; 7.5×10⁻¹⁰ Torr).

In an embodiment, the double-wall tank comprises a thermal insulation layer provided in the gap between the inner wall and the outer wall, said thermal insulation layer being arranged enveloping at least partially the inner wall.

Other particular embodiments of a thermal insulation layer comprise at least one of the following materials: aerogel, bubble wrap and/or foam material.

In a more particular embodiment, the inner and/or outer walls are composed of a thermoset carbon fiber reinforced polymer (“CFRP-TS”).

Regarding the geometric configuration of the double-wall tank, in one embodiment the inner and outer chambers have the same shape, wherein the outer chamber housing the inner chamber has a larger size.

In one embodiment, the inner and outer walls comprise at least one dome-shaped portion, said portions being arranged facing one another, each dome-shaped portion having a convex outer side and a concave inner side.

It shall be understood that, regarding the orientation or disposition of the dome-shaped portions, the concave inner side will be oriented towards the interior of the tank.

From an architectural and geometric perspective, a dome-shaped structure, in the sense of the present invention, may be understood as a spherical cap, that is, as any portion of a sphere resulting from being cut by a plane. It may also have slightly different concave-convex shapes such as for example a paraboloid shape.

In a more particular embodiment, the inner connecting part and/or the outer connecting part of the piping connecting system are arranged at the dome-shaped portions of the inner or outer wall.

In one embodiment, the inner and outer chambers have a spherical shape.

In one embodiment, the two chambers have two dome-shaped portions disposed at two ends of a central cylindrical section.

In an embodiment, at least one pipe is arranged passing through corresponding outer and inner part holes, parallel to the axis of the cylindrical section of each chamber.

In an embodiment, at least one inner connecting part is a bushing coupled, by means of a fluid-tight fit, to a corresponding inner wall hole.

In an embodiment, the bushing comprises a cylindrical main body and a flange projecting radially outwardly from the cylindrical main body, wherein said flange is arranged on an inner side of the inner wall facing the interior of the inner chamber when the bushing is arranged on the inner wall.

In a case where the gap between the inner wall and the outer wall is under vacuum conditions, the direction of the operating pressures to which the inner wall and the outer wall, as well as the elements attached to them, are exposed, will be opposite. In particular, in the case of the inner wall, the pressure is positive from the inside of the inner chamber, towards the outside of the inner chamber, i.e. towards the intermediate space between the inner wall and the outer wall. By arranging the flange on the side of the inner wall facing the interior of the inner chamber, the vacuum suction favors the efficiency of the connection tightness at the interfaces between the inner wall and the bushing, as the pressure exerts a force to keep the contact between both elements. Furthermore, said flange serves as a mechanical obstacle that prevents the bushing from uncoupling due to the effect of vacuum suction.

In an embodiment, at least one outer connecting part is a bushing coupled, by means of a fluid-tight fit, to a corresponding outer wall hole.

In an embodiment, the bushing comprises a cylindrical main body and a flange projecting radially outwardly from the cylindrical main body, wherein said flange is arranged on an outer side of the outer wall facing the outside of the tank when the bushing is arranged on the outer wall.

The outer wall is subjected to a negative pressure from the outside of the tank towards the intermediate gap between the inner wall and the outer wall. By arranging the flange on the side of the outer wall facing the outside of the tank, the vacuum suction favors the efficiency of the connection tightness at the interfaces between the outer wall and the bushing, as the pressure exerts a force to keep the contact between both elements. Furthermore, said flange serves as a mechanical obstacle that prevents the bushing from uncoupling due to the effect of vacuum suction.

In an embodiment, at least one bushing is embedded into a corresponding inner or outer wall made of FRP material.

The bushing may have been provided at intermediate stages of the manufacture and consolidation of said inner or outer wall, or inserted, after said wall has been completely cured, within a built-in hole or groove provided during the manufacturing process.

There may be a “co-bonding” or “adhesive” joint line between the resin of the FRP material of the corresponding wall and the bushing coupled thereto. Said joint line ensures, in the particular case of the inner wall, the tightness of the inner vessel (i.e., the inner chamber intended for housing the fluid) and, in the particular case of the outer wall, the vacuum conditions maintained in the intermediate gap defined between the inner wall and the outer wall.

In a more particular embodiment, the inner or outer wall in which the bushing is embedded is made of a CFRP-TS, which provides a robust assembly, with optimal mechanical strength and sealing properties.

In an embodiment, at least one bushing and the corresponding wall to which the bushing is coupled are provided, respectively, with a frustoconical geometry.

In particular, according to said frustoconical geometry, the minor base of the bushing is oriented towards the intermediate gap between the inner wall and the outer wall. In this way, the effect of the pressure difference between each side of the wall, presses the bushing and the inner wall against each other along their respective conical surfaces, thus promoting the contact between them and increasing the structural integrity of the resulting assembly as well as the tightness of the joint.

In an embodiment, the inner wall and the outer wall comprise, respectively, a plurality of inner wall holes and outer wall holes, wherein the tank further comprises a plurality of pipes and wherein each of the plurality of pipes is arranged passing:
through an outer wall hole; and
through an inner wall hole.

In a preferred embodiment, each one of the inner wall holes and the outer wall holes is crossed by only one pipe at a time.

In an embodiment, at least one inner connecting part comprises a plurality of inner part holes and/or the tank comprises a plurality of inner connecting parts; the one or more inner connecting parts being positioned relative to the inner wall such that the inner part holes and the inner wall holes are coincident.

In an embodiment, at least one outer connecting part comprises a plurality of outer part holes and/or the tank comprises a plurality of outer connecting parts; the one or more outer connecting parts being positioned relative to the outer wall such that the outer part holes and the outer wall holes are coincident.

The piping connecting system may include one or more inner connecting parts and one or more outer connecting parts. Each inner connecting part may include one or more inner part holes and each outer connecting part may include one or more outer part holes to allow access of one or more pipes. Thus, the required number of inner/outer part holes may be provided arranging one or more inner/outer connecting parts each having one or more inner/outer part holes.

In an embodiment, at least one of the inner or outer connecting part is configured as a sheet having a shape that matches the shape of the corresponding inner or outer wall to which the inner or outer connecting part is coupled.

In a particular embodiment in which at least one of the inner and outer wall has a dome-shaped portion on which the corresponding inner/outer connecting part is arranged, said connecting part also comprises a dome-shaped geometry, that is, a curved sheet with a spherical cap shape. In an embodiment, said inner/outer connecting part comprises a number of part holes identical to the number of wall holes provided on the corresponding inner or outer wall on which the connecting part is coupled.

In an embodiment, at least a portion of the inner wall and at least a portion of the inner connecting part surrounding the inner part holes are overwrapped by a layer of FRP material.

In an embodiment, at least a portion of the outer wall and at least a portion of the outer connecting part surrounding the outer part holes are overwrapped by a layer of FRP material.

Advantageously, by overwrapping, at least partially, the inner/outer connecting part and the inner/outer wall with FRP material, the inner/outer connecting part becomes embedded in FRP material, improving its coupling and structural integrity with the inner/outer wall.

In an embodiment, the gap between the inner wall and the outer wall is under vacuum conditions.

In an embodiment, at least one inner connecting part and/or at least one outer connecting part is metallic, preferably made of INVAR.

INVAR is an austenitic nickel-iron alloy which has an extremely low coefficient of thermal expansion (CTE) from −250° C. to 200° C. Additionally, INVAR has good fatigue and mechanical properties at cryogenic temperatures.

Advantageously, the elements made of INVAR contribute to minimize the thermal loads arising due to the temperature gradients experienced on each element, as well as to avoid corrosion issues in their contact with the elements which may be made of a polymeric material.

Advantageously, this embodiment enables welding technology for the coupling between the inner/outer connecting part and the pipe, thus providing a better tightness behavior and ultra-vacuum maintenance.

Additionally, in embodiments wherein elements made with INVAR and CFRP-TS are combined, such as embodiments in which a bushing made of INVAR is embedded into an inner or outer wall made of CFRP-TS, the stress produced by the thermal expansion of the coupled elements is reduced. This is due to INVAR and CFRP-TS having similar coefficients of thermal expansion.

In an embodiment, at least one inner connecting part and/or at least one outer connecting part is made of FRP, preferably a thermoplastic carbon fiber reinforced polymer (“CFRP-TP”).

Advantageously, providing connecting parts according to this embodiment optimizes weight saving, tightness behavior and contributes to maintain ultra-high vacuum (UHV) conditions in the intermediate gap defined between the inner wall and the outer wall, everything while coping with thermal expansion and limiting corrosion.

Additionally, in an embodiment wherein the connecting part is coupled to a corresponding wall made of FRP material, the welding of said connecting part made with CFRP-TP to the corresponding wall is preferably performed using:
only resin or
a resin wire with carbon fiber.

According to this embodiment, the mechanical properties of the weld are optimized.

In a second inventive aspect, the invention provides a method for assembling a double-wall tank according to any embodiment of the first inventive aspect, the method comprising the following steps:
i) providing an inner wall portion defining at least partially an inner chamber configured to house a fluid;
ii) providing an inner connecting part comprising at least one inner part hole;
iii) coupling the inner connecting part to the inner wall portion;
iv) providing an outer wall portion defining at least partially an outer chamber, said outer chamber being configured to house the inner chamber within;
v) providing an outer connecting part comprising at least one outer part hole;
vi) coupling the outer connecting part to the outer wall portion;
vii) providing at least one pipe;
viii) introducing at least a portion of the pipe through an inner part hole and through an inner wall hole;
ix) coupling, by means of a fluid-tight fit, the pipe in said inner part hole;
x) introducing at least a portion of the pipe through an outer part hole and through an outer wall hole;
xi) coupling, by means of a fluid-tight fit, the pipe in said outer part hole,
wherein the inner wall portion provided in step i) comprises at least one inner wall hole or the method comprises making at least one inner wall hole in the inner wall portion after step i),
and wherein the outer wall portion provided in step iv) comprises at least one outer wall hole or the method comprises making at least one outer wall hole in the outer wall portion after step iv).

In some embodiments the process of making a hole in the inner wall portion and/or in the outer wall portion, depending on the size of the hole, may include carrying out drilling and/or trimming tasks. Also, machining tasks may be carried out in case it is necessary to provide particular geometries required for the precise coupling of the parts involved.

Examples of such geometries may comprise providing a hole with a peripheral groove when any connecting part comprises a stepped profile caused by a peripheral flange, or with a frustoconical shape to receive a frustoconical connecting part.

In other embodiments, the process of making a hole in the inner and/or outer wall portion encompasses the manufacturing of the wall with such hole in it. In other words, the hole is generated during the manufacturing process of the wall without having to further machine the wall to obtain such hole.

Regarding the coupling of the connecting parts to the corresponding inner or outer wall, according to steps iii) and vi), it shall be understood that they are coupled by means of a fluid-tight fit.

In an embodiment, step iii) comprises arranging the inner connecting part relative to the inner wall portion such that the inner part hole and the inner wall hole of the inner wall portion are coincident.

In an embodiment, step vi) comprises arranging the outer connecting part relative to the outer wall such that the outer part hole and the outer wall hole of the outer wall are coincident.

In an embodiment, the at least one inner wall hole is made, after step iii), by means of a drilling and/or trimming process carried out through an inner part hole.

In an embodiment, the at least one outer wall hole is made, after step ix), by means of a drilling and/or trimming process carried out through an outer part hole.

Advantageously, in an embodiment wherein at least one inner and/or outer connecting part comprises a plurality of inner and/or outer part holes, making the inner and/or outer wall holes through the inner or outer part holes, such as by carrying out the necessary steps of drilling, trimming and/or machining, allows using the holes of the inner or outer part as reference, thus assuring the coincidence of holes in the inner/outer wall portion and holes in the inner/outer part.

In an embodiment, the method comprises the step of providing at least one layer of FRP material overwrapping:
at least a portion of the inner wall portion; and
at least a portion of the inner connecting part surrounding the inner part holes.

In an embodiment, the method comprises the step of providing at least one layer of FRP material overwrapping:
at least a portion of the outer wall portion; and
at least a portion of the outer connecting part surrounding the outer part holes.

In an embodiment, the method comprises a step of trimming FRP material of the corresponding inner or outer wall around the edges of the holes, if needed.

In an embodiment, at least one inner connecting part is a bushing comprising a cylindrical main body and a flange projecting radially outwardly from the cylindrical main body, and step iii) comprises arranging the bushing on the side of the inner wall portion configured for facing the interior of the inner chamber.

In an embodiment, at least one outer connecting part is a bushing comprising a cylindrical main body and a flange projecting radially outwardly from the cylindrical main body, and step ix) comprises arranging the bushing on the side of the outer wall portion configured for facing the outside of the tank.

In an embodiment, at least one bushing is embedded into a corresponding inner or outer wall made of FRP material.

In an embodiment, the inner wall portion and/or the outer wall portion is made of FRP material.

In an embodiment, the inner wall portion provided at step i) and/or the outer wall portion provided at step iv) is made of fresh FRP material, partially cured FRP material or completely cured FRP material.

The properties of any FRP structure, or composite material, are determined by the manufacturing process conditions. Accordingly, a “partially cured”, or “pre-cured”, FRP structure or element, should be understood as a structure composed of composite materials which have undergone an incomplete curing cycle, or “partial curing cycle” compared to the application of a complete curing cycle under predetermined duration and temperature conditions according to which the FRP structures have reached the desired chemical and mechanical properties, and so can be considered as “completely cured”, or just “cured”.

Accordingly, the partially cured FRP structures are processed so as to reach a degree of cure according to which the matrix has a higher molecular weight than typical resins in order to reduce resin flow, which provides a certain stiffness which facilitates handling, storage and later processing properties.

In an embodiment wherein the inner wall portion provided at step i) and/or the outer wall portion provided at step iv) is made of fresh or partially cured FRP material, the method comprises a step of curing the assembly of the inner wall portion, the outer wall portion, the coupled inner and outer connecting parts and the coupled pipe.

This curing process of fresh or partially cured elements allows to consolidate the aforementioned elements after they have been provided and coupled according to the steps of the method, thus resulting in a sequential concept which allows said elements to be integrated in a much more efficient and flexible manner compared to other configurations wherein the walls of the tank are manufactured as a monolithic/single piece and/or in a one-shot process.

In an embodiment wherein the method comprises a step of trimming excess FRP material at the edges of the holes, the trimming step may be performed before or after the curing cycle.

In an embodiment, the method comprises coupling the inner/outer wall portion to at least one additional inner/outer wall portion to configure a complete inner/outer chamber. In an embodiment wherein the tank comprises a cylindrical portion with dome-shaped ends, the inner/outer wall portion is one dome-shaped end and the additional inner/outer wall portions are the cylindrical portion and the other dome-shaped end.

In an embodiment, the method comprises wrapping with FRP material the assembly of the inner/outer wall portion and the at least one additional inner/outer wall portion and consolidating said portions by at least one of the following processes: co-curing or co-bonding.

According to a more particular embodiment, in the event that there is excess FRP material on the edges of the holes, or that it is necessary to perform trimming or machining tasks on the walls, such trimming and/or machining operations are performed after the step of partially or totally wrapping the connecting part with FRP material.

Examples of lay-up techniques regarded to manufacture the inner and/or outer walls provided in steps i) and iv), respectively, as well as the inner and/or outer connecting parts, when they are made of FRP material are Automated Tape Laying (ATL) or Automated Fiber Placement (AFP). Both processes are functionally similar, comprising applying resin-impregnated fiber material (“prepregs”). “Prepregs” are composite materials made from “pre-impregnate” fibers and a partially cured polymer matrix, such as epoxy or phenolic resin, or even thermoplastic. The matrix is used to bond the fibers together. The curing process induces chemical reactions that create extensive cross-linking between polymer chains to produce an infusible and insoluble polymer network. During cross-linking at sufficiently high temperatures, the material changes from a liquid via a gel into a glass-like solid.

However, each process is used differently to achieve specific structure construction goals to provide strength or stiffness where needed. Particularly, the use of one or the other mainly depends on the geometry complexity of the part to manufacture, in which AFP allows higher curvatures.

Filament winding techniques are also regarded as techniques suitable for manufacturing the inner and/or outer walls provided in steps i) and iv), respectively, as well as the inner and/or outer connecting parts, when they are made of FRP material.

A “filament winding” technique should be understood as a composite material structures manufacturing process used mainly for hollow parts, generally circular or oval section components, such as pipes and containers, and consisting of winding tensioned reinforcing fiber filaments and/or tapes, impregnated with a thermosetting resin, on male mold or mandrel. Conventionally, said male mold is rotated, while a carriage moves horizontally, orienting the fibers in the desired pattern. Once the male mold is completely covered to the desired thickness and distribution pattern of filaments, the resin may be cured. Once the resin has been cured, the male mold is removed (unmold process), leaving the final product hollow.

Filament winding is a process that can be automated, where the tension of the filaments can be carefully controlled. The orientation of the filaments can also be carefully controlled so that the layers are laminated and oriented differently from the previous layer. The angle at which the fiber of the lower layers is established determines the properties of the final product.

Examples of “tooling” used for manufacturing a FRP structure comprise:
molds;
vacuum bags;
caul plates;
heating equipment;
Typically, a number of composite plies or tapes are laid-up one upon the other on a mold, thus resulting in a stack of plies. In this regard, a “ply” should be understood as a single continuous area of composite material to be laid on a form, where two plies in the same layer do not normally overlap. The laying-up of plies forms a stack which is known as a “laminate” or as a whole “preform”. The molds, mandrels or male molds should be regarded as shaping surfaces for manufacturing an item on the mold so that the item acquires the shape of the mold at least on its face in contact with the mold.

Additionally, the fibrous material reinforcement may be glass (for Glass Fiber Reinforcement Polymer, “GRFP”), carbon (for Carbon Fiber Reinforcement Polymer, “CRFP”), polymer fibers or any other conventional material used as reinforcement. Among them, carbon is preferred.

All the features described in this specification (including the claims, description and drawings) and/or all the steps of the described method can be combined in any combination, with the exception of combinations of such mutually exclusive features and/or steps.

### DESCRIPTION OF THE DRAWINGS

These and other characteristics and advantages of the invention will become clearly understood in view of the detailed description of the invention which becomes apparent from a preferred embodiment of the invention, given just as an example and not being limited thereto, with reference to the drawings.

FIG. 1 shows a schematic view of a transverse section of a portion of a double-wall tank according to an embodiment of the invention.

FIG. 2 shows a schematic representation of a connecting part of a double-wall tank according to an embodiment of the invention.

FIG. 3 shows a schematic view of a transverse section of a portion of double-wall tank according to an embodiment of the invention.

FIG. 4 shows a schematic view of a transverse section of a portion of a double-wall tank according to an embodiment of the invention.

FIG. 5 shows a schematic view of a transverse section of a portion of the inner wall of a double-wall tank according to an embodiment of the invention.

FIG. 6 shows a schematic view of a transverse section of a portion of a double-wall tank according to an embodiment of the invention.

### DETAILED DESCRIPTION OF THE INVENTION

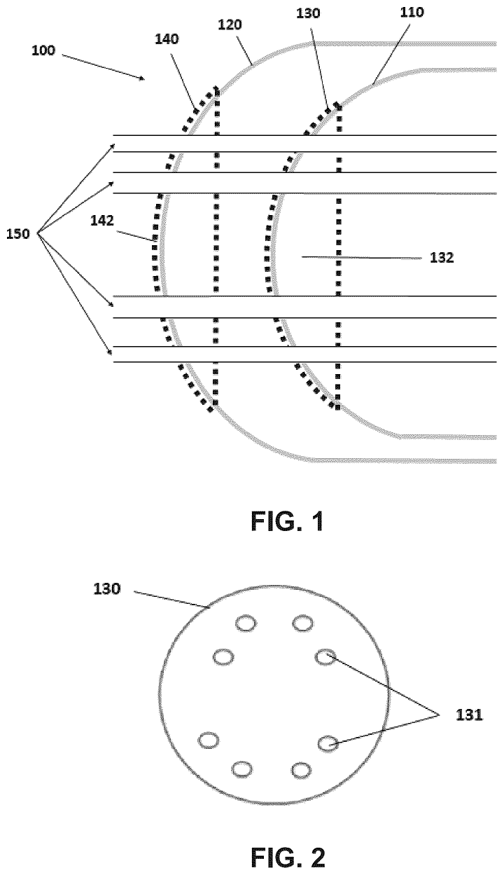

FIG. 1 shows a schematic view of a transverse section of a portion of double-wall tank (100) according to an embodiment of the invention.

The double-wall tank (100) shown comprises four basic structural elements:
an inner chamber intended for housing a fluid within, and which is defined by the inner wall (110) of the so called double-wall tank (100);
an outer chamber, defined by the outer wall (120), which is arranged surrounding said inner chamber, said inner (110) and outer (120) walls being separated a distance defined by an intermediate gap between them, which, in the particular embodiment shown in FIG. 1 is under vacuum conditions;
a piping connecting system which comprises an inner connecting part (130) coupled to the inner wall (110) and an outer connecting part (140) coupled to the outer wall (120); and
pipes (150), which in the particular embodiment shown are eight (four of them being shown in the schematic front view provided, the other four being arranged behind), passing through the outer (120) and inner (110) walls, as well as through the piping connecting system, each of the pipes being coupled to said piping connecting system.

The piping connecting system and the pipes (150) are configured to allow access to the inner chamber, while assuring the tightness of the fluid stored inside the inner chamber and allowing keeping vacuum in the gap between the inner wall (110) and the outer wall (120).

Regarding the vacuum condition in said gap between the inner wall (110) and the outer wall (120), in the embodiment shown gas is pumped out of the inner chamber until reaching ultra-high vacuum (UHV) conditions. According to this vacuum regime, operating pressure is lower than about 100 nano Pascals (1.0×10⁻⁷ Pa; 1.0×10⁻⁹ mbar; 7.5×10⁻¹⁰ Toff).

In the embodiment shown in FIG. 1, both the inner (110) and outer (120) walls comprise each eight respective wall holes, while the inner (130) and outer (140) connecting parts comprise each eight corresponding part holes, the inner (130) and outer (140) connecting parts being positioned relative to the inner (110) and outer (120) walls such that the corresponding inner/outer wall holes and the inner/outer part holes are coincident, to let each of the eight pipes (150) pass through.

As can be seen, regarding the geometric configuration of the double-wall tank (100), the inner and outer chambers have the same shape, wherein the outer chamber housing the inner chamber has a larger size. Additionally, the inner (110) and outer (120) walls comprise one dome-shaped portion arranged facing one another, each dome-shaped portion having a convex outer side and a concave inner side oriented towards the interior of the tank (100).

Additionally, for both chambers (i.e., the inner vessel defined by the inner wall (110), and the outer jacket defined by the outer wall (120)), only one of the two longitudinal ends is shown. It shall be understood that the complete embodiment of the schematic double-wall tank (100) shown comprises a symmetrical distribution for the inner chamber and the outer chamber, wherein two corresponding dome-shaped portions are spaced by a cylindrical central section. However the tank (100) may comprise connecting parts (130, 140) and pipes (150) crossing its walls (110, 120) at only one longitudinal end of its two opposite longitudinal ends.

In this sense, regarding the connections (not shown) necessary to fix and maintain the position of the inner chamber with respect to the outer chamber, preferably such connections will be provided only on one of the two ends of both the inner and outer chambers. More specifically, in the embodiment shown, said connections will be arranged on the dome-shaped portions shown for both the inner chamber and the outer chamber.

The inner (130) and outer (140) connecting parts of the piping connecting system are arranged at the dome-shaped portions of the inner (110) or outer (120) walls, respectively. Preferably, said dome-shaped portions of the inner (110) or outer (120) walls are the same portions where the connections (not shown) to fix and maintain the position of the inner chamber with respect to the outer chamber are provided.

In relation to said inner (130) and outer (140) connecting parts, further details of them are provided in FIG. 2, where a front view of a schematic representation is depicted. As can be seen, in this embodiment said inner (130) and outer (140) connecting parts are configured as a curved sheet provided with a dome-shaped geometry.

Finally, in the embodiment shown in FIG. 1, both the inner (130) and outer (140) dome-shaped connecting parts are made of INVAR, and the pipes (150) are metallic, each of them being welded to the inner (130) and outer (140) connecting parts through respective inner/outer part holes.

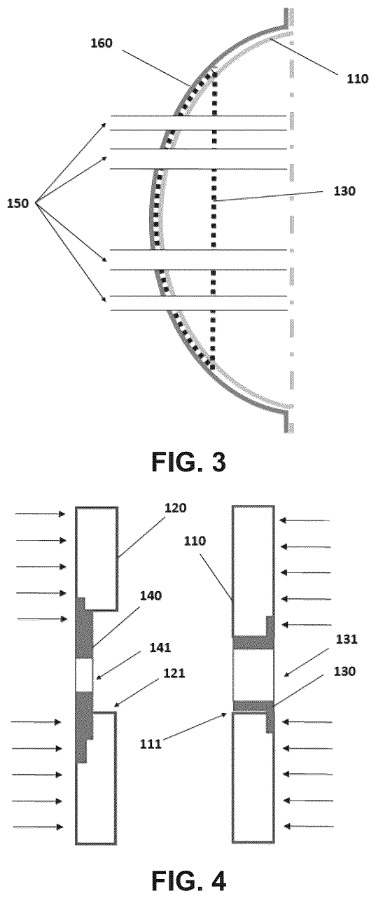

FIG. 3 shows an embodiment as the one shown in FIG. 1, but including a layer (160) of FRP material overwrapping a portion of the inner chamber and/or the outer chamber. For illustrative purposes, only an example of said layer (160) of FRP material is shown for the inner chamber. In particular, the layer of FRP material (160) is shown provided over the portion of inner wall (110) shown, as well as over the inner connecting part (130) coupled to said portion of inner wall (110). According to this embodiment, by overwrapping the inner connecting part (130) and the inner wall (110) with FRP material, the inner connecting part (130) becomes embedded in FRP material, improving its coupling, tightness and structural integrity with the inner wall (110).

Additionally, as can be seen, no layer of FRP material is provided over the part holes of the inner connection part (130), as the material would impede the passage of the pipes (150) through the corresponding part holes and wall holes.

FIG. 4 shows a schematic view of a transverse section of a portion of double-wall tank (100) according to an embodiment of the invention. More particularly, FIG. 4 focuses on providing constructive details of another configuration for the piping connection system. For this purpose, it shows schematically an enlarged view of the passage area of a pipe (150) through the inner and outer chambers. With regard to said piping connection system, it can be seen that, instead of a single dome-shaped structure comprising a plurality of holes in a number matching the plurality of holes provided in the corresponding wall (110, 120), both the outer connecting part (130) and the inner connecting part (140) are configured as two respective bushings that are coupled, and more specifically inserted, into two respective inner (111) and outer (121) wall holes.

Additionally, as can be seen, both bushings (130, 140) comprise a cylindrical main body and a flange projecting radially outwardly from said cylindrical main body, as well as corresponding inner part (131) and outer part (141) holes. Each bushing (130, 140) is inserted into the inner (110) and outer (120) wall, respectively, such that the inner part (131) and the outer part (141) holes are coincident with the corresponding inner (111) and outer (121) wall holes. More in particular, the inner part (131) and outer part (141) holes and the inner (111) and outer (121) wall holes are concentric, respectively.

Regarding the inner connecting part (130), it can be seen that the flange is arranged on the side of the inner wall (110) facing the interior of the inner chamber.

By arranging the flange of the bushing (130) on the side of the inner wall (110) facing the interior of the inner chamber, the vacuum suction originated in the intermediate gap between the inner wall (110) and the outer wall (120) favors the efficiency of the connection tightness at the interfaces between the inner wall (110) and the bushing (130), as the pressure exerts a force to keep the contact between both elements. Furthermore, said flange serves as a mechanical obstacle that prevents the bushing (130) from uncoupling due to the effect of vacuum suction.

In turn, regarding the outer connecting part (140), it can be seen that the flange is arranged on the side of the outer wall (120) facing the exterior of the outer chamber.

By arranging the flange on the side of the outer wall (120) facing the outside of the tank, the vacuum suction favors the efficiency of the connection tightness at the interfaces between the outer wall (120) and the bushing (140), as the pressure exerts a force to keep the contact between both elements. Furthermore, said flange serves as a mechanical obstacle that prevents the bushing (140) from uncoupling due to the effect of vacuum suction.

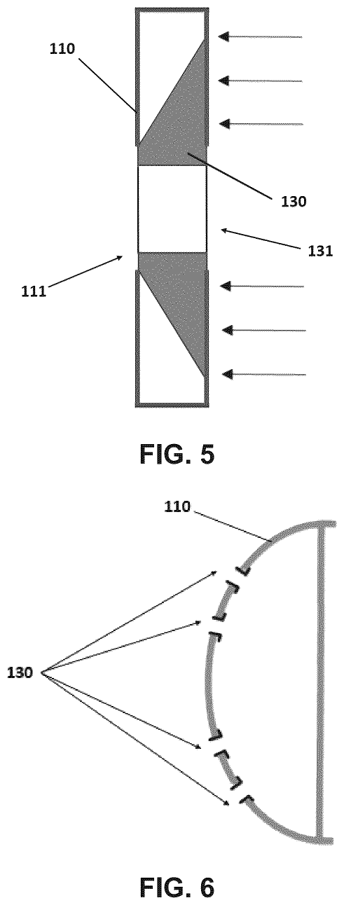

FIG. 5 shows a schematic view of a transverse section of a portion of the inner wall (110) of a double-wall tank (100) according to an embodiment of the invention. In particular, the configuration of the inner wall (110) shown is similar to that of FIG. 4. However, in this case, both the inner wall (110) itself and the bushing (130) shown coupled, and more specifically inserted, into the inner wall hole (111), are provided, respectively, with a frustoconical geometry.

As can be seen, said frustoconical geometry, in the cross-section shown, is represented as a trapezoidal shape of both the bushing (130) and the inner wall hole (111). In this trapezoidal shape, the major base is oriented towards the inside of the inner chamber intended for housing a pressurized fluid, and the minor base is oriented towards the intermediate gap between the inner wall (110) and the outer wall (120) intended to be under vacuum conditions. In this way, the effect of the pressure differential, which is shown with arrows pointing towards the inner surface of the inner wall (110), presses the bushing (130) and the inner wall (110) against each other along their respective conical surfaces, thus promoting the contact between them and increasing the structural integrity of the resulting assembly as well as the tightness of the joint.

Additionally, in relation to such coupling between the bushing (130) and the inner wall (110), in the embodiment shown, the bushing (130) is embedded in the inner wall (110). This integration is represented by means of part of the thick dark line delimiting the boundaries of the inner wall (110) extending and overlapping over a portion of the inner side of the bushing (130) (i.e., the major base of the trapezoidal shape). More specifically, one or more layer of a FRP laminate forming the inner wall (110) overlap on the inner face of the bushing (130).

The inner wall (110), in this particular case, is composed of a CFRP-TS. In this regard, according to the embodiment shown, both the process of embedding the bushing (130) and the provision of the conical geometry of the inner wall hole (111) take place at intermediate stages of the manufacture and consolidation of said inner wall (110), which ultimately results in a robust assembly, with optimal mechanical strength and sealing properties by, for example, a metal weld joint between the bushing (130) and the pipe (150) passing through it, compared to alternatives made solely of CFRP-TP.

Finally, although the details of the conical surface of the inner wall (110) in contact along the same with the bushing (130) are not shown, in an embodiment said surface has a stepped profile, as a result of the sequential arrangement of layers of a laminate of the composite material, each successive layer of the laminate having displaced wider hole in it with respect to a previous layer to give rise to said frustoconical surface.

FIG. 6 shows a schematic view of a transverse section of a portion of double-wall tank (100) according to an embodiment of the invention. More in particular, using a configuration as the one shown in FIG. 4 for the inner connecting parts (130), i.e. by implementing bushings inserted into the inner wall holes and optionally embedded into the inner wall (110). FIG. 6 shows an inner wall (110) portion comprising four inner wall holes, wherein inside of each an inner connecting part (130) in the form of a bushing has been coupled.

Furthermore, as can be seen, said bushings (130) comprise a having a main cylindrical body and a flange projecting from the main cylindrical body, the flange abutting the inner face of the inner wall (110), such that said flange exerts resistance to the vacuum suction generated in the intermediate gap arranged between the inner wall (110) and the outer wall (120).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A double-wall tank comprising:
an inner wall defining an inner chamber configured to house a fluid, wherein the inner wall comprises at least one inner wall hole;
an outer wall defining an outer chamber which houses the inner chamber within, wherein the outer wall comprises at least one outer wall hole,
a piping connecting system comprising:
at least one inner connecting part coupled to the inner wall, wherein the at least one inner connecting part comprises at least one inner part hole, and wherein the at least one inner connecting part is positioned relative to the inner wall such that the at least one inner part hole and the at last one inner wall hole of the inner wall are coincident; and
at least one outer connecting part coupled to the outer wall, wherein the at least one outer connecting part comprises at least one outer part hole, and wherein the at least one outer connecting part is positioned relative to the outer wall such that the at least outer part hole and the at least one outer wall hole of the outer wall are coincident; and
at least one pipe passing through:
the at least one outer part hole and the at least one outer wall hole; and
the at least one inner part hole and the at least one inner wall hole,
wherein the at least one pipe is coupled, by means of a fluid-tight fit, to the at least one inner part hole and the at least one outer part hole.

2. The tank according to claim 1, wherein the at least one inner connecting part, the at least one outer connecting part, or both is a bushing coupled, by means of a fluid-tight fit, to a corresponding inner or outer wall hole.

3. The tank according to claim 2, wherein the bushing comprises a cylindrical main body and a flange projecting radially outwardly from the cylindrical main body, wherein said flange is arranged, when the bushing is arranged on the inner wall, on an inner side of the inner wall facing the interior of the inner chamber and, when the bushing is arranged on the outer wall, on an outer side of the outer wall facing the outside of the tank.

4. The tank according to claim 1, wherein the inner wall and the outer wall comprise, respectively, a plurality of inner and outer wall holes, wherein the tank comprises a plurality of pipes, arranged passing:
through an outer wall hole; and
through an inner wall hole.

5. The tank according to claim 4, wherein the at least one inner connecting part comprises a plurality of inner part holes, wherein the tank comprises a plurality of inner connecting parts, or both, and wherein the one or more inner connecting parts are positioned relative to the inner wall such that the one or more inner part holes and the inner wall holes are coincident; or
wherein at least one outer connecting part comprises a plurality of outer part holes, the tank comprises a plurality of outer connecting parts, or both, and wherein the one or more outer connecting parts are positioned relative to the outer wall such that the outer part holes and the outer wall holes are coincident.

6. The tank according to claim 1, wherein at least a portion of the inner wall, the outer wall, or both, and at least a portion of the connecting parts surrounding the part holes are overwrapped by a layer of Fiber Reinforced Polymer (FRP) material.

7. The tank according to claim 1, wherein a gap between the inner wall and the outer wall is under vacuum conditions.

8. The tank according to claim 1, wherein the inner wall, the outer wall, or both is made of Fiber Reinforced Polymer (FRP) material.

9. The tank according to claim 1, wherein the at least one inner connecting part, the at least one outer connecting part, or both is metallic.

10. The tank according to claim 1, wherein the at least one inner connecting part, the at least one outer connecting part, or both is made of Fiber Reinforced Polymer (FRP).

11. A method for assembling a double-wall tank, the method comprising the following steps:
i) providing an inner wall portion defining at least partially an inner chamber configured to house a fluid;
ii) providing an inner connecting part comprising at least one inner part hole;
iii) coupling the inner connecting part to the inner wall portion;
iv) providing an outer wall portion defining at least partially an outer chamber, said outer chamber being configured to house the inner chamber within;
v) providing an outer connecting part comprising at least one outer part hole;
vi) coupling the outer connecting part to the outer wall portion;
vii) providing at least one pipe;
viii) introducing at least a portion of the at least one pipe through the at least one inner part hole and through an inner wall hole;
ix) coupling, by a fluid-tight fit, the at least one pipe in the at least one inner part hole;
x) introducing at least a portion of the at least one pipe through the at least one outer part hole and through an outer wall hole;
xii) coupling, by a fluid-tight fit, the at least one pipe in the at least one outer part hole,
wherein the inner wall portion provided in step i) comprises the inner wall hole,
and wherein the outer wall portion provided in step iv) comprises the outer wall hole.

12. The method according to claim 11 further comprising:
making the inner wall hole in the inner wall portion.

13. The method according to claim 11 further comprising:
making the outer wall hole in the outer wall portion.

14. The method according to claim 11, wherein:
step iii) comprises arranging the at least one inner connecting part positioned relative to the inner wall portion such that the inner part hole and the inner wall hole of the inner wall portion are coincident; or
step vi) comprises arranging the at least one outer connecting part positioned relative to the outer wall such that the outer part hole and the outer wall hole of the outer wall are coincident.

15. The method according to claim 11, wherein
the inner wall hole is made, after step iii), by a drilling process, a trimming process, or both carried out through an inner part hole; or
the outer wall hole is made, after step ix), by a drilling process, a trimming process, or both carried out through an outer part hole.

16. The method according to claim 1 further comprising the step of:
providing at least one layer of FRP material overwrapping at least a portion of the inner wall portion, the outer wall portion, or both, at least a portion of the at least one inner connecting part, the at least one outer connecting part, or both surrounding the inner or outer part holes.

17. The method according to claim 1, wherein the at least one inner connecting part, the at least one outer connecting part, or both comprise a bushing comprising a cylindrical main body and a flange projecting radially outwardly from the cylindrical main body, and wherein step iii), step ix), or both comprises arranging the bushing:
on the side of the inner wall portion configured for facing the interior of the inner chamber when the bushing is arranged in the inner wall portion, or
on the side of the outer wall portion configured for facing the outside of the tank when the bushing is arranged in the outer wall portion.
